(19) United States
(12) Patent Application Publication
(10) Pub. No.: US 2026/0264409 A1
(43) Pub. Date: Sep. 10, 2026

(54) LIQUID EJECTION DEVICE

(71) Applicant: SEIKO EPSON CORPORATION, Tokyo (JP)

(72) Inventor: Kiyoto TAKEDA, Shiojiri-shi (JP)

(21) Appl. No.: 19/561,695

(22) Filed: Mar. 10, 2026

(30) Foreign Application Priority Data
Mar. 10, 2025 (JP) 2025-037582

(51) Int. Cl. B41J 2/165; B41J 2/17

(52) U.S. Cl. CPC B41J 2/16544; B41J 2/16505; B41J 2/1721

(57) ABSTRACT

A liquid ejection device includes a liquid ejection head that ejects liquid onto a medium to perform recording; a waste liquid storage tank that stores waste liquid generated by the liquid ejection head ejecting the liquid; a waste liquid absorption member that is provided in the waste liquid storage tank and that is configured to absorb the waste liquid; and a rotating body that rotates while contacting a surface of the waste liquid absorption member.

The present application is based on, and claims priority from JP Application Serial Number 2025-037582, filed Mar. 10, 2025, the disclosure of which is hereby incorporated by reference herein in its entirety.

### BACKGROUND

### 1. Technical Field

The present disclosure relates to a liquid ejection device that ejects liquid onto a medium to perform recording.

### 2. Related Art

The ink jet recording device of JP-A-2002-178542 is provided with an absorbing body in a waste ink tank. Then, by applying air flow generated by a suction fan to the vicinity of a waste ink introduction section of the absorbing body, the evaporation rate of moisture in the waste ink increases, so it will take longer until the absorbing body becomes saturated with waste ink.

In the configuration described in JP-A-2002-178542, when drying of the waste ink near the surface of the absorption member is accelerated, a thickened ink layer is formed, and the waste ink newly introduced into the waste ink tank is less likely to be absorbed through the surface of the absorbing body, that is, the absorbing capability of the absorbing body may decrease.

### SUMMARY

A liquid ejection device according to the present disclosure for solving the above problem includes a liquid ejection head that ejects liquid onto a medium to perform recording; a waste liquid storage tank that stores waste liquid generated by the liquid ejection head ejecting the liquid; a waste liquid absorption member that is provided in the waste liquid storage tank and that is configured to absorb the waste liquid; and a rotating body that rotates while contacting a surface of the waste liquid absorption member.

### BRIEF DESCRIPTION OF THE DRAWINGS

FIG. 1 is an external perspective view of a printer.

FIG. 2 is a diagram illustrating a medium transport path of the printer.

FIG. 3 is a block diagram illustrating a control system of the printer.

FIG. 4 is a perspective view of a maintenance unit.

FIG. 5 is a perspective view of a part of a first power transmission section that transmits power from a transport motor to a suction pump and a part of a second power transmission section that transmits power from the transport motor to a rotating body.

FIG. 6 is a cross-sectional view of a waste liquid storage tank.

FIG. 7 is a plan view of a part of the waste liquid storage tank and a part of the second power transmission section.

FIG. 8 is a cross-sectional view of a waste liquid storage tank.

FIG. 9 is a cross-sectional view of a waste liquid storage tank.

FIG. 10 is a cross-sectional view of a waste liquid storage tank.

FIG. 11 is a cross-sectional view of a waste liquid storage tank.

### DESCRIPTION OF EMBODIMENTS

The present disclosure will be schematically described below.

A liquid ejection device according to a first aspect includes a liquid ejection head that ejects liquid onto a medium to perform recording; a waste liquid storage tank that stores waste liquid generated by the liquid ejection head ejecting the liquid; a waste liquid absorption member that is provided in the waste liquid storage tank and that is configured to absorb the waste liquid; and a rotating body that rotates while contacting a surface of the waste liquid absorption member.

According to the aspect, the waste liquid is absorbed by the waste liquid absorption member provided in the waste liquid storage tank. Here, by providing the rotating body that rotates while being in contact with the surface of the waste liquid absorption member, a layer of thickened waste liquid tends not to form in a region contacted by the rotating body at the surface of the waste liquid absorption member, and the waste liquid absorbing capability of the waste liquid absorption member can be maintained.

A second aspect is an aspect according to the first aspect, wherein the waste liquid storage tank forms a box shaped body and the waste liquid absorption member and the rotating body are disposed inside the box shaped body.

According to this aspect, in the configuration in which the waste liquid storage tank forms a box shaped body, the operational effects of the first aspect described above are obtained.

A third aspect is an aspect according to the second aspect, wherein the waste liquid storage tank includes an upper container and a lower container that is located below the upper container and that is attachable to and detachable from the upper container, wherein the rotating body is provided to the upper container, and the waste liquid absorption member is provided to the lower container.

According to this aspect, since the rotating body is provided in the upper container and the waste liquid absorption member is provided in the lower container, the waste liquid absorption member can be replaced by separating the upper container and the lower container, and the rotating body can be continuously used, so that running cost can be suppressed.

A fourth aspect is an aspect according to the first aspect, wherein the rotating body is configured by providing, on a rotation shaft, blades that elastically deform by contact with the waste liquid absorption member.

According to this aspect, since the rotating body is configured by providing, on the rotation shaft, the blade that elastically deforms by contact with the waste liquid absorption member, it is possible to effectively maintain the waste liquid absorbing capability of the surface of the waste liquid absorption member and to configure the rotating body with a simple configuration.

It should be noted that this aspect is not limited to the first aspect, and may be according to the second or third aspect.

A fifth aspect is an aspect according to the first aspect, wherein plural rotating bodies are provided.

According to this aspect, since plural rotating bodies are provided, the waste liquid absorbing capability can be maintained over a wide range of the surface of the waste liquid absorption member.

It should be noted that this aspect is not limited to the first aspect, and may be according to any one of the second to fourth aspects.

A sixth aspect is an aspect according to the first aspect, wherein the rotating body includes a plurality of pulleys, a belt that is wound around the pulleys and that rotates, and a wiper that is provided on the belt and that elastically deforms by contact with the waste liquid absorption member.

According to this aspect, since the rotating body includes a plurality of pulleys, a belt that is wound around the plurality of pulleys and that rotates, and a wiper that is provided on the belt and that elastically deforms by coming into contact with the waste liquid absorption member, it is possible to effectively secure the area where the wiper contacts the surface of the waste liquid absorption member, and to maintain the waste liquid absorbing capability in a wide range over the surface of the waste liquid absorption member.

It should be noted that this aspect is not limited to the first aspect, and may be according to the second or third aspect.

A seventh aspect is an aspect according to the first aspect, wherein the rotating body is formed of a material configured to absorb the waste liquid and the waste liquid absorption member is provided so as to be driven to rotate by contact with the rotating body.

According to this aspect, since the rotating body is formed of a material capable of absorbing the waste liquid and the waste liquid absorption member is provided so as to be driven to rotate in contact with the rotating body, the surface of the waste liquid absorption member can contact the rotating body across a wide range, and the waste liquid absorbing capability can be maintained in a wide range over the surface of the waste liquid absorption member.

It should be noted that this aspect is not limited to the first aspect, and may be according to the second or third aspect.

An eighth aspect is an aspect according to the first aspect, wherein the waste liquid guided to the waste liquid absorption member is discharged from above the rotating body toward the rotating body.

According to this aspect, since the waste liquid guided to the waste liquid absorption member is discharged from above the rotating body toward the rotating body, the waste liquid guided to the waste liquid absorption member is less likely to stay at one place on the surface of the waste liquid absorption member, and a layer in which the waste liquid is thickened is less likely to be formed.

It should be noted that this aspect is not limited to the first aspect, and may be according to any one of the second to seventh aspects.

A ninth aspect is an aspect according to the first aspect, further including a transport roller that transports the medium in a transport path through which the medium is transported and a motor that drives the transport roller, wherein the rotating body rotates by receiving power from the motor.

According to the aspect, since the rotating body rotates by obtaining power from the motor that drives the transport roller, a dedicated power source that rotates the rotating body is not necessary, and it is possible to suppress an increase in cost and an increase in size of the device.

A tenth aspect is an aspect according to the ninth aspect, further including a cap configured to face the liquid ejection head; a suction pump coupled to the cap; and a power transmission section that, assuming that rotation direction of the motor when the medium is transported downstream by the transport roller is a forward rotation direction, transmits power of the motor to the suction pump when the motor rotates in a reverse rotation direction that is opposite to the forward rotation direction, wherein the rotating body rotates in a first direction when the motor rotates in the forward rotation direction, and rotates in a second direction opposite to the first direction when the motor rotates in the reverse rotation direction.

According to this aspect, since the motor further drives the suction pump, a dedicated power source for driving the suction pump is not required, and an increase in cost and size of the device can be further suppressed.

Since the rotating body rotates in the first direction when the motor rotates in the forward rotation direction and rotates in the second direction, which is opposite to the first direction, when the motor rotates in the reverse rotation direction, compared to a configuration in which the rotating body rotates only in a fixed direction, it is possible to secure an area where the rotating body contacts the surface of the waste liquid absorption member, and it is possible to more favorably maintain the waste liquid absorbing capability of the waste liquid absorption member.

Hereinafter, the present disclosure will be described in detail.

Hereinafter, an ink jet printer 1 that performs recording by ejecting ink, which is an example of a liquid, onto a medium represented by a recording sheet will be described as an example of a liquid ejection device. Hereinafter, the ink jet printer 1 will be abbreviated as the printer 1.

An X-Y-Z coordinate system shown in each drawing is an orthogonal coordinate system, and a direction indicated by an arrow is a + direction and the opposite direction is a - direction. The Y-axis direction is a transport direction of the medium during recording and is a device depth direction. In the present embodiment, among the side surfaces constituting the periphery of the printer 1, the side surface in the +Y direction is the front surface, and the side surface in the -Y direction is the back surface.

The X axis direction is the device width direction, and the +X direction is the left side and the -X direction is the right side when viewed from by the operator of the printer 1. The X-axis direction is the medium width direction.

The Z-axis direction is a vertical direction, that is, a device height direction, and the +Z direction is an upward direction and the -Z direction is a downward direction.

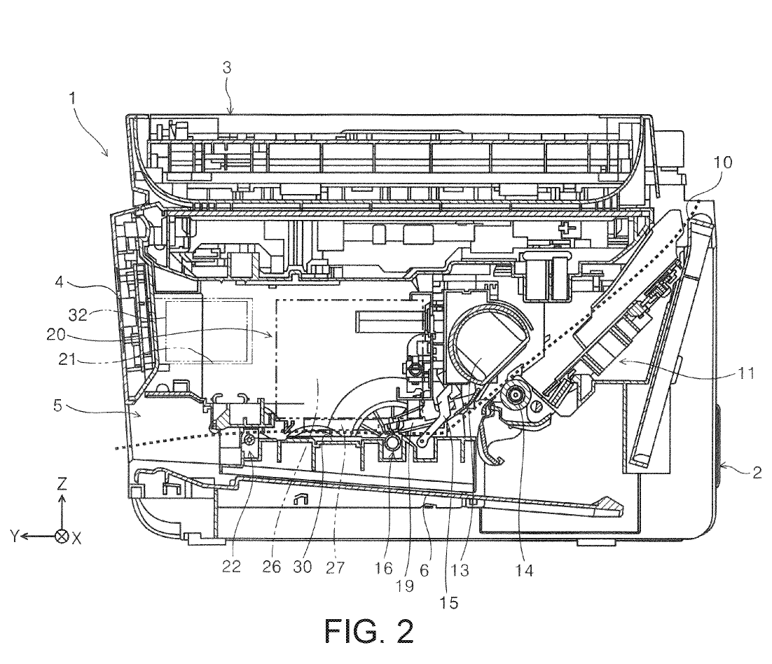

Hereinafter, a direction in which the medium is fed may be referred to as "downstream", and a direction opposite to this may be referred to as "upstream". In FIG. 2, a transport path 10 of the medium is indicated by broken line. In the printer 1, the medium is transported through a transport path 10.

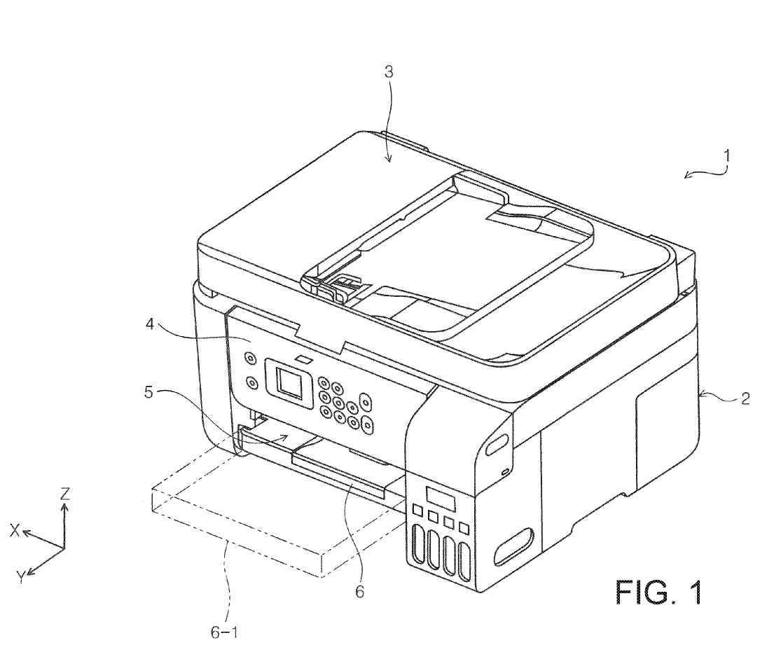

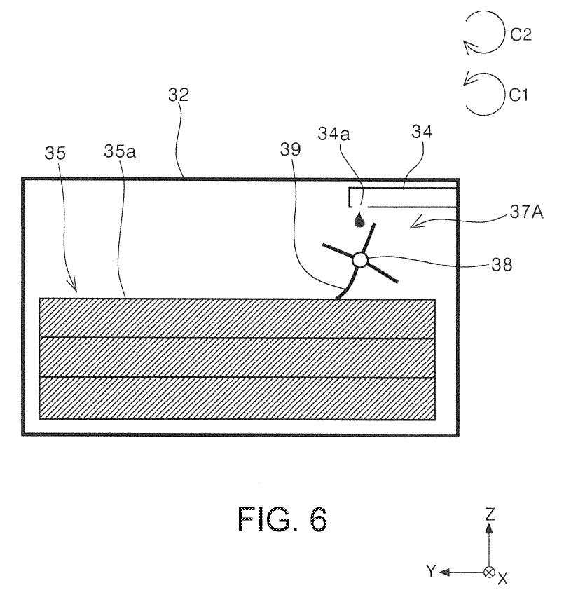

As illustrated in FIGS. 1 and 2, the printer 1 is configured as a multifunction machine including a recording unit 2 and a scanner section 3 disposed on the recording unit 2. An operation panel 4 is provided on the device front surface of the recording unit 2. The operation panel 4 is tiltable, and can take a closed state, which is a posture in which a panel surface is substantially vertical (FIGS. 1 and 2), and an open state, which is a posture in which the panel surface is substantially horizontal (not illustrated). When the operation panel 4 is opened, a waste liquid storage tank 32 (see FIGS. 2 and 6, to be described later) can be attached and detached. In FIG. 2, reference numeral 21 denotes a mounting section to which the waste liquid storage tank 32 is mounted. The mounting section 21 is open in the +Y direction and is formed to have a size capable of receiving the waste liquid storage tank 32.

A discharge port 5 is formed on the front surface of the recording unit 2. A medium reception tray 6 is provided at the discharge port 5. The medium reception tray 6 is configured to be capable of switching between a housed state (solid line in FIG. 1) and a pulled-out state (two dot chain line indicated by reference numeral 6-1 in FIG. 1) with respect to the recording unit 2.

As illustrated in FIG. 2, a medium support section 11 that supports the medium to be fed in an inclined posture is provided upstream in the transport path 10. It should be noted that examples of the medium in the present embodiment include medium having different sizes such as paper of A4 size or B5 size, photographic paper, and postcards.

The medium supported by the medium support section 11 is nipped by the feed roller 13 and the separation roller 14 and is sent toward the transport roller pair 16.

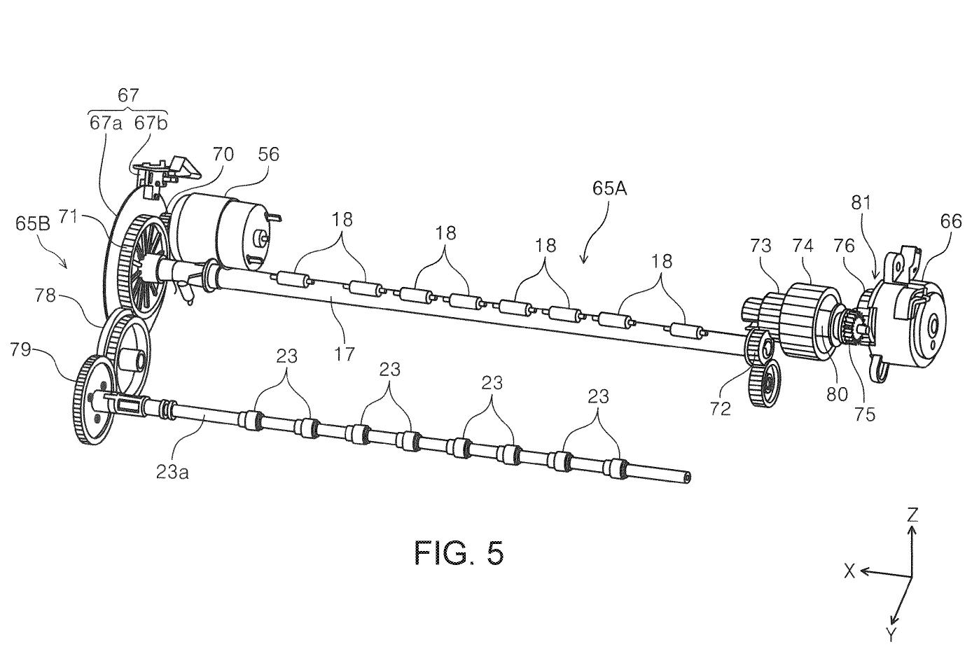

The transport roller pair 16 includes a transport drive roller 17 (refer to FIG. 5) that is rotationally driven, and a transport driven roller 18 (refer to FIG. 5) that nips the medium between itself and the transport drive roller 17. The transport drive roller 17 is an example of a transport roller provided upstream of the liquid ejection head 27 in the transport path 10. The transport driven roller 18 is rotatably supported by a roller support member 19.

A medium detection sensor 15 that detects passage of the medium is provided upstream of the transport roller pair 16 in the transport path 10. The medium is transported to a recording position of the recording section 20 by the transport roller pair 16, based on detection information by the medium detection sensor 15.

The recording section 20 includes a carriage 26 and a liquid ejection head 27. The carriage 26 is configured to be capable of reciprocating in the X-axis direction. The liquid ejection head 27 is provided on a lower portion of the carriage 26. The liquid ejection head 27 is provided with a plurality of ink ejecting nozzles (not illustrated) capable of ejecting ink in the -Z direction.

A facing section 30 that supports the medium is provided at a position that can oppose the liquid ejection head 27. The facing section 30 defines the distance between the medium and the liquid ejection head 27. The liquid ejection head 27 ejects ink onto the medium supported by the facing section 30, and performs recording on the recording surface of the medium. The medium on which recording has been executed is nipped by the discharge roller pair 22 provided downstream of the liquid ejection head 27 in the transport path 10 and is discharged toward the medium reception tray 6.

The discharge roller pair 22 is provided downstream of the liquid ejection head 27 in the transport path 10 and transports the medium. The discharge roller pair 22 includes a discharge drive roller 23 (see FIG. 5) that is driven to rotate, and a discharge driven roller (not illustrated) that nips the medium between itself and the discharge drive roller 23.

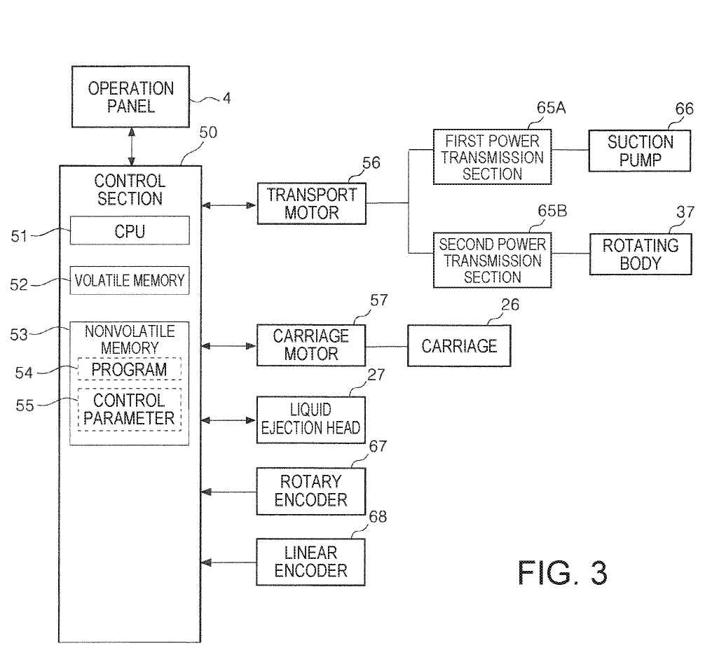

Next, a control system of the printer 1 will be described with reference to FIG. 3. It should be noted that in FIG. 3, only the configuration necessary for the following description is shown, and the other configuration is not illustrated.

The control section 50 performs various controls of the printer 1. The operation panel 4, a transport motor 56, a carriage motor 57, the liquid ejection head 27, a rotary encoder 67, and a linear encoder 68 are connected to the control section 50.

Each of the motors is, for example, a DC motor. The control section 50 includes a driver circuit (not illustrated) for driving each motor.

The transport motor 56 is a common drive source of the transport drive roller 17, the discharge drive roller 23, a suction pump 66 (to be described later), and a rotating body 37 (to be described later). The suction pump 66 receives power from the transport motor 56 via a first power transmission section 65A. The rotating body 37 receives power from the transport motor 56 via a second power transmission section 65B.

It should be noted that in the following description, the rotation direction of the transport motor 56 when the medium is being transported in the +Y direction, that is, downstream, is referred to as a forward rotation direction, and the opposite direction to that is referred to as a reverse rotation direction. Although details will be described later, when the transport motor 56 rotates in the forward rotation direction, the transport drive roller 17 and the discharge drive roller 23 rotate forward. In this case, power is not transmitted to the suction pump 66 and the suction pump 66 does not operate. In this case, the rotating body 37 rotates in a first direction.

When the transport motor 56 rotates in the reverse rotation direction, the transport drive roller 17 and the discharge drive roller 23 rotate in the reverse rotation direction. In this case, power is transmitted to the suction pump 66, and the suction pump 66 operates. In this case, the rotating body 37 rotates in a second direction.

The carriage motor 57 is a drive source of the carriage 26.

The rotary encoder 67 detects rotation of the transport drive roller 17. The control section 50 can detect the rotation direction, the rotation amount, and the rotation speed of the transport motor 56 based on the output signal of the rotary encoder 67.

The linear encoder 68 detects the position of the carriage 26. The control section 50 can detect the position and the moving speed of the carriage 26 based on the output signal of the linear encoder 68.

The control section 50 controls display of the operation panel 4, receives information transmitted from the operation panel 4, and performs various types of control.

The control section 50 includes a central processing unit (CPU) 51 that executes a computer program, in other words, software, a volatile memory 52, and a nonvolatile memory 53.

The CPU 51 performs various calculations necessary for executing the program 54 stored in the nonvolatile memory 53. The volatile memory 52 is used as a temporary storage area and as a work area when the CPU 51 executes the program 54. The nonvolatile memory 53 stores a program 54 and a control parameter 55 necessary for executing the program 54. The program 54 includes a program for executing various processes described later, and the control parameter 55 includes a parameter for executing the program 54. Various processes in the printer 1 are realized by the control section 50 executing the program 54.

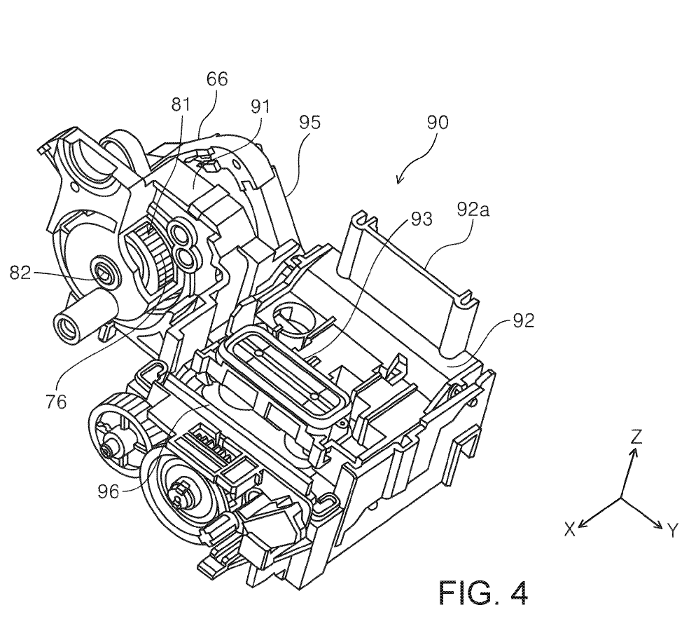

Next, the maintenance unit 90 including the suction pump 66 will be described with reference to FIGS. 4 and 5.

As shown in FIG. 4, the maintenance unit 90 has a unit frame 91 as a base body, and components such as the suction pump 66 and a slide base 92 are provided on the unit frame 91. The slide base 92 is slidable in the X-axis direction with respect to the unit frame 91 and also is provided so as to be displaceable in the +Z direction in accordance with its sliding in the -X direction. The slide base 92 is pressed in the +X direction by a spring (not illustrated).

The slide base 92 is provided with a cap 93.

The maintenance unit 90 is internally provided at the -X direction end section. When the carriage 26 moves to the -X direction end section, the liquid ejection head 27 can face the cap 93.

The slide base 92 is provided with an engagement section 92a, and the carriage 26 can abut against the engagement section 92a. At the stage where the carriage 26 moves in the -X direction and abuts against the engagement section 92a, a gap is formed between the head surface (not illustrated) of the liquid ejection head 27 and the cap 93. The position of the carriage 26 at this time is referred to as a cap facing position.

When the carriage 26 further moves in the -X direction from the cap facing position, the slide base 92 moves in the -X direction together with the carriage 26. By this, the cap 93 rises and the cap 93 comes into intimate contact with the head surface (not illustrated) of the liquid ejection head 27. The position of the carriage 26 at this time is referred to as a cap intimate contact position.

During print standby, the carriage 26 is located at the cap intimate contact position. When the process of eliminating nozzle clogging in the liquid ejection head 27 is performed, the suction pump 66 is driven in a state where the carriage 26 is positioned at the cap intimate contact position. The cap 93 and the suction pump 66 are connected by a tube 95, and a negative pressure is formed in the cap 93 by operation of the suction pump 66.

In a flushing operation, ink is ejected from the liquid ejection head 27 to the cap 93 in a state where the carriage 26 is located at the cap facing position. By this, when ink accumulates in the cap 93, the suction pump 66 is driven to suck the ink in the cap 93.

The suction pump 66 is connected to a waste liquid storage tank 32 (to be described later) by an ink tube (not illustrated). The ink sucked by the suction pump 66 is sent as waste liquid to the waste liquid storage tank 32 by the action of the suction pump 66.

It should be noted that a wiper 96 is provided on the slide base 92, and when the carriage 26 moves in the -X direction, the head surface 27a is wiped by the wiper 96.

The unit frame 91 is provided with a time lag mechanism 81. The time lag mechanism 81 constitutes the first power transmission section 65A (to be described later) (see FIG. 5). The time lag mechanism 81 is a mechanism that provides a time lag in power transmission after the rotation of the transport motor 56 is switched from the forward rotation direction to the reverse rotation direction. By this, even when the rotation of the transport motor 56 is switched from the forward rotation direction to the reverse rotation direction, the suction pump 66 does not immediately operate and a time lag occurs until the suction pump 66 starts operating.

FIG. 5 illustrates the first power transmission section 65A that transmits power from the transport motor 56 to the suction pump 66, and the second power transmission section 65B that transmits power from the transport motor 56 to the rotating body 37. The transport motor 56 is provided in the vicinity of the +X direction end section of the transport drive roller 17. A gear 70 is provided on a motor shaft of the transport motor 56, and power is transmitted from the gear 70 to a gear 71. The gear 71 is a gear provided at +X direction end section of the transport drive roller 17. A gear 78 meshes with the gear 71, and the gear 78 meshes with a gear 79.

The gear 79 is a gear provided at the +X direction end section of the rotation shaft 23a of the discharge drive roller 23. It should be noted that although another gear is further engaged with the gear 79, the gear is omitted in FIG. 5. With the above configuration, power is transmitted from the transport motor 56 to the transport drive roller 17 and the discharge drive roller 23.

The gear 70, the gear 71, the gear 78, and the gear 79 constitute the second power transmission section 65B.

It should be noted that the gear 71 is provided with a rotary scale 67a, and the rotary scale 67a is inserted into the detection section 67b. The rotary scale 67a and the detection section 67b constitute a rotary encoder 67.

Next, a gear 72 is provided at the -X direction end section of the transport drive roller 17, and power is transmitted from the gear 72 to a gear 73. The gear 73 and the gear 74 are integrally formed, and power is transmitted from the gear 74 to the feed roller 13 (see FIG. 2) via a gear (not illustrated).

A one way clutch (not illustrated) is provided inside the gear 74 and, by the function of the one way clutch, power is transmitted from the gear 74 to the shaft 80 only when the transport motor 56 rotates in the reverse rotation direction. Note that a one way clutch may be provided inside the suction pump 66.

The shaft 80 is provided with a gear 75, and power is transmitted from the gear 75 to a gear 76 constituting a time lag mechanism 81, and further, power is transmitted to the suction pump 66 via the time lag mechanism 81.

The gear 70, the gear 71, the transport drive roller 17, the gear 72, the gear 73, and the gear 74, the shaft 80, the gear 75, and the time lag mechanism 81 constitute the first power transmission section 65A.

Next, the waste liquid storage tank 32 and the rotating body 37 will be described with reference to FIG. 6 and subsequent drawings. It should be noted that in the following description, the rotating body 37 has a plurality of embodiments and, in each embodiment, the rotating body is denoted by the reference numeral 37 and with an alphabet capital letter added to it. However, the rotating body of the respective embodiments may be collectively referred to as a rotating body 37.

In FIG. 6, the waste liquid storage tank 32 forms a box shaped body. It should be noted that the waste liquid storage tank 32 is not limited to a box shaped body and may have a structure in which the upper portion is open.

A waste liquid absorption member 35 is provided inside the waste liquid storage tank 32. As the waste liquid absorption member 35, a sponge having ink absorbency can be adopted as an example. However, the waste liquid absorption member 35 may be made of other materials having ink absorbency such as nonwoven fabric.

The waste liquid storage tank 32 is provided with a needle fitting section 34, and the waste liquid fed from the suction pump 66 drips from an opening 34a provided in the needle fitting section 34. The needle fitting section 34 will be further described later.

A rotating body 37A is provided above the waste liquid absorption member 35.

The rotating body 37A has a rotation shaft 38 extending in the X-axis direction. The rotation shaft 38 extends in the X-axis direction and is rotatably supported in the waste liquid storage tank 32. The rotation shaft 38 is provided with blades 39 that are elastically deformed by contacting the surface 35a of the waste liquid absorption member 35. In the present embodiment, a plurality of blades 39 are provided around the rotation shaft 38. The blades 39 can be made of an elastically deformable material such as rubber.

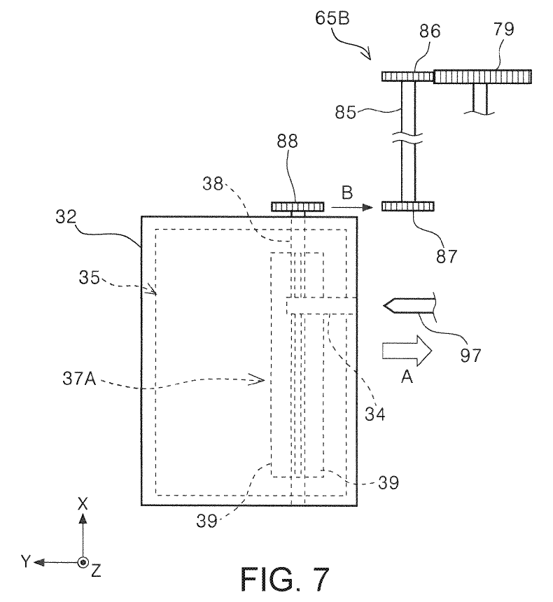

Here, transmission of the driving force to the rotation shaft 38 will be described with reference to FIG. 7.

FIG. 7 illustrates a state in which the waste liquid storage tank 32 is being mounted onto the mounting section 21 (see FIG. 2), and the waste liquid storage tank 32 is being mounted in the direction of arrow A. In the present embodiment, the direction of the arrow A is the -Y direction.

The gear 79 (see FIG. 5) described above is engaged with a gear 86. The gear 86 is provided at the +X direction end section of the shaft 85. A gear 87 is provided at the -X direction end section of the shaft 85. The gear 86, the shaft 85, and the gear 87 are components on the device main body side.

In the waste liquid storage tank 32, a gear 88 is provided at the +X direction end section of the rotation shaft 38. When the waste liquid storage tank 32 is mounted in the direction of the arrow A, the gear 88 moves in the direction of arrow B and can mesh with the gear 87. The gear 86, the shaft 85, and the gear 87 constitute the second power transmission section 65B.

As described above, the power of the transport motor 56 is transmitted to the rotation shaft 38, that is, the rotating body 37A via the second power transmission section 65B. Such a power transmission structure is the same in other embodiments described below.

A waste liquid discharge needle 97 is provided on the device main body side. The waste liquid is sent to the waste liquid discharge needle 97 from the suction pump 66 via an ink tube (not illustrated). When the waste liquid storage tank 32 is mounted in the direction of the arrow A, the waste liquid discharge needle 97 fits into the needle fitting section 34 provided in the waste liquid storage tank 32 and, by this, the waste liquid sent from the suction pump 66 flows into the waste liquid storage tank 32.

In the above configuration, the waste liquid is absorbed by the waste liquid absorption member 35 provided in the waste liquid storage tank 32. Here, by providing the rotating body 37 that rotates while contacting the surface 35a of the waste liquid absorption member 35, a layer of thickened waste liquid is less likely to form on the surface 35a of the waste liquid absorption member 35 in the region contacted by the rotating body 37, and the waste liquid absorbing capability of the waste liquid absorption member 35 can be maintained. By this, the waste liquid can be suppressed from overflowing before the waste liquid absorption member 35 reaches the limit of its original waste liquid absorbing capability.

In the present embodiment, since the rotating body 37A is configured by providing the blades 39, which elastically deform by contact with the waste liquid absorption member 35, on the rotation shaft 38, it is possible to effectively maintain the waste liquid absorbing capability of the surface 35a of the waste liquid absorption member 35 and to configure the rotating body 37A with a simple configuration.

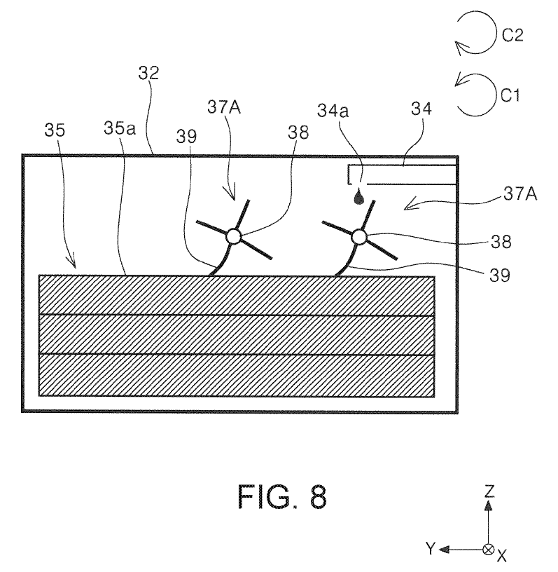

It should be noted that a plurality of the rotating body 37A may be provided as shown in FIG. 8. According to such a configuration, the waste liquid absorbing capability can be maintained over a wide range of the surface 35a of the waste liquid absorption member 35.

It should be noted that although two rotating bodies 37A are provided in FIG. 8, three or more may be provided.

In the present embodiment, the waste liquid guided to the waste liquid absorption member 35 is discharged from above the rotating body 37 toward the rotating body 37. According to such a configuration, the waste liquid guided to the waste liquid absorption member 35 is less likely to stay at one place on the surface 35a of the waste liquid absorption member 35, and a layer of thickened waste liquid is less likely to be formed. This is also true of other embodiments described below.

In the present embodiment, the rotating body 37 rotates by obtaining power from the transport motor 56. According to such a configuration, a dedicated power source for rotating the rotating body 37 is not required, and an increase in cost and size of the device can be suppressed. This is also true of other embodiments described below.

In the embodiment, the printer 1 includes the cap 93 (refer to FIG. 4), which can face the liquid ejection head 27, and the suction pump 66 (refer to FIG. 4), which is connected to the cap 93.

The printer 1 also has the first power transmission section 65A that transmits the power of the transport motor 56 to the suction pump 66 when the transport motor 56 rotates in the reverse rotation direction, which is opposite to the forward rotation direction, with the forward rotation direction being the direction of rotation of the transport motor 56 when the medium is transported downstream by the transport drive roller 17 (see FIG. 5).

In FIGS. 6 and 8, the rotating body 37 rotates in a first direction C1 when the transport motor 56 rotates in the forward rotation direction, and rotates in a second direction C2, which is opposite to the first direction C1, when the transport motor 56 rotates in the reverse rotation direction.

According to such a configuration, a dedicated power source for driving the suction pump 66 is not required, and an increase in the cost and size of the device can be further suppressed.

Since the rotating body 37A rotates in the first direction C1 when the transport motor 56 rotates in the forward rotation direction and rotates in the second direction C2, which is opposite to the first direction C1, when the transport motor 56 rotates in the reverse rotation direction, it is possible to secure an area in which the rotating body 37 contacts the surface 35a of the waste liquid absorption member 35 and to more favorably maintain the waste liquid absorbing capability of the waste liquid absorption member 35, compared to a configuration in which the rotating body 37A were to rotate only in a fixed direction. This is also true of other embodiments described below.

However, the rotating body 37 may rotate only in a fixed direction. A dedicated motor for driving the rotating body 37 may be provided.

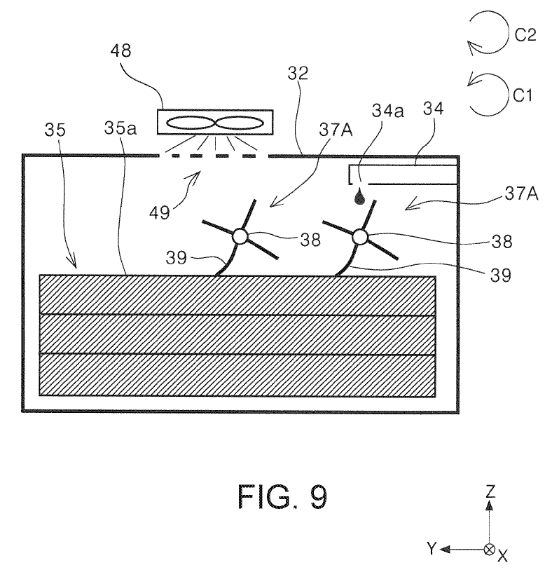

It should be noted that as shown in FIG. 9, a ventilation port 49 may be provided in the upper section of the waste liquid storage tank 32 so that the air sent from a fan 48 hits the surface 35a of the waste liquid absorption member 35. With this configuration, evaporation of moisture in the waste liquid absorption member 35 is promoted, and a decrease in the waste liquid absorbing capability of the waste liquid absorption member 35 can be suppressed. In such a configuration, a thickened layer of the waste liquid is easily formed on the surface 35a of the waste liquid absorption member 35, but such a problem can be suppressed by providing the rotating body 37A as described above.

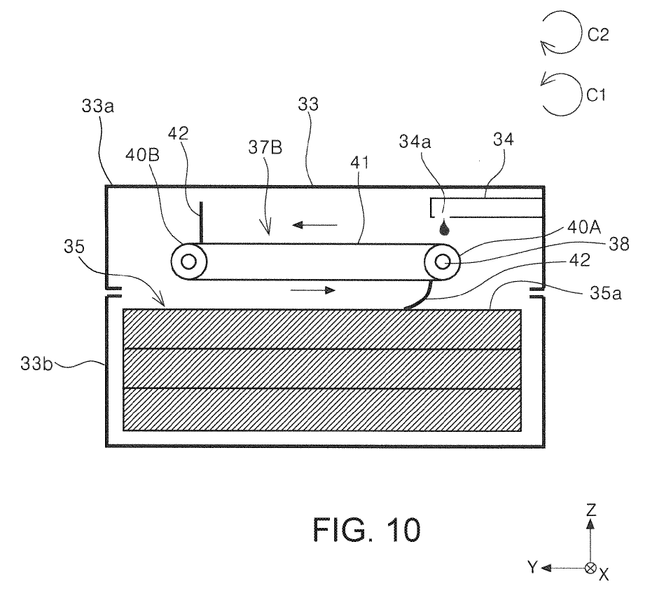

Next, another embodiment will be described with reference to FIG. 10.

The rotating body 37B shown in FIG. 10 includes a drive pulley 40A, a driven pulley 40B, an endless belt 41 that is wound around these two pulleys and that rotates, and a wiper 42 provided on the endless belt 41. The drive pulley 40A is provided on the above-described rotation shaft 38, that is, it rotates by obtaining power from the transport motor 56.

The wiper 42 is formed of an elastically deformable material, for example, rubber, and elastically deforms by contacting the waste liquid absorption member 35.

When the rotation shaft 38 rotates, the endless belt 41 rotates and, by this, the wiper 42 wipes the surface 35a of the waste liquid absorption member 35. In FIG. 10, the arrow of the endless belt 41 indicates the rotation direction of the endless belt 41 when the rotation shaft 38, that is, the drive pulley 40A, rotates in the first direction C1.

According to such a configuration, the area where the wiper 42 contacts the surface 35a of the waste liquid absorption member 35 can be effectively secured, and the waste liquid absorbing capability can be maintained over a wide range on the surface 35a of the waste liquid absorption member 35.

It should be noted that although two wipers 42 are provided in FIG. 10, only one wiper 42 may be provided, or three or more wipers 42 may be provided.

A scraping portion that scrapes off the waste liquid adhering to the wiper 42 contacting the wiper 42 may be provided inside the waste liquid storage tank 33.

It should be noted that in FIG. 10, reference numeral 33 denotes a waste liquid storage tank, which is a modification of the waste liquid storage tank 32 described above. The waste liquid storage tank 33 includes an upper container 33a and a lower container 33b that is located below the upper container 33a and that is attachable to and detachable from the upper container 33a.

The rotating body 37B is provided in the upper container 33a, and the waste liquid absorption member 35 is provided in the lower container 33b.

According to such a configuration, by separating the upper container 33a and the lower container 33b, the waste liquid absorption member 35 can be replaced and the rotating body 37B can be continuously used, so that running costs can be suppressed.

It should be noted that such a waste liquid storage tank 33 is also applicable to the embodiment described with reference to FIGS. 6 to 9 and other embodiments described below.

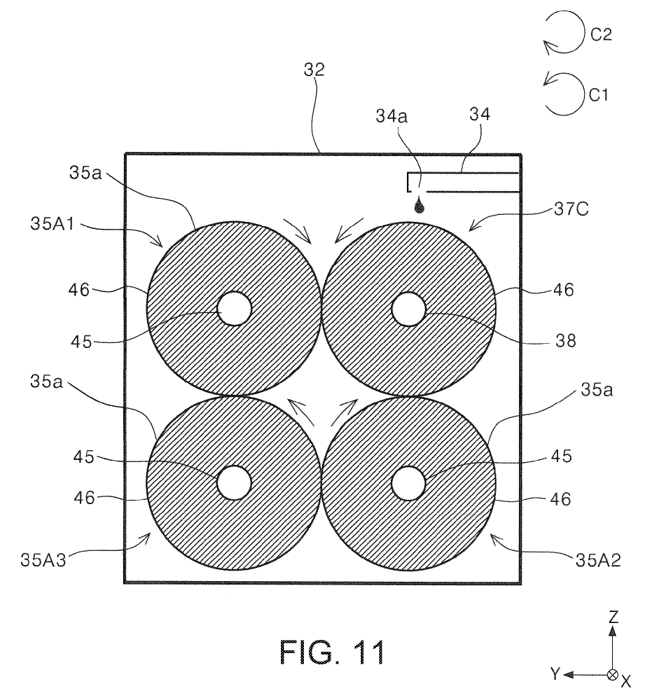

Next, another embodiment will be described with reference to FIG. 11.

The rotating body 37C according to the present embodiment is formed by an absorption body 46 capable of absorbing waste liquid, and rotates by rotation of the rotation shaft 38. As the absorption body 46, a sponge having ink absorbency can be adopted as an example. However, the absorption body 46 may be made of other materials having ink absorbency such as nonwoven fabric.

In the present embodiment, the waste liquid absorption member is also rotatable. The symbols 35A1, 35A2, and 35A3 respectively denote waste liquid absorption members. These waste liquid absorption members are configured by providing an absorption body 46 on a rotation shaft 45. The rotation shaft 45 extends in the X axis direction and is provided to be rotatable with respect to the waste liquid storage tank 32.

The waste liquid absorption member 35A1 and the waste liquid absorption member 35A2 are driven to rotate in contact with the rotating body 37C. The waste liquid absorption member 35A3 is driven to rotate in contact with the waste liquid absorption member 35A1 and the waste liquid absorption member 35A2. In FIG. 11, the arrows appended to the waste liquid absorption members 35A1, 35A2, and 35A3 indicate rotation direction when the rotating body 37C rotates in the first direction C1.

It should be noted that in the present embodiment, the rotating body 37C and the waste liquid absorption members 35A1, 35A2, and 35A3 have the same configuration and the same dimensions, and the same components can be used.

The absorption bodies 46 are provided so as to deform to some extent at a section where the absorption bodies 46 are in contact with each other. In other words, the absorption body 46 is in a state of being squashed to some extent at the portion where the absorption bodies 46 are in contact with each other.

According to the above configuration, the waste liquid absorption members 35A1 and 35A2 can contact the rotating body 37C across a wide range, to be specific, over the entire range, and the waste liquid absorbing capability can be maintained over a wide range of the surface 35a of the waste liquid absorption members 35A1 and 35A2. The waste liquid absorption member 35A3 can also contact the waste liquid absorption members 35A1 and 35A2 across a wide range, concretely, across the whole range, and the waste liquid absorbing capability can be maintained over a wide range of the surface 35a of the waste liquid absorption member 35A3.

The present disclosure is not limited to the embodiments and the modifications described above, and various modifications are possible within the scope of the disclosure described in the claims, and it is needless to say that they are also included in the scope of the present disclosure.

For example, the waste liquid storage containers 32 and 33 may store waste liquid discarded in the facing section 30 (see FIG. 2) for performing borderless recording, instead of the waste liquid sent out from the suction pump 66 or in addition to the waste liquid sent out from the suction pump 66.

What is claimed is:

1. A liquid ejection device comprising:
a liquid ejection head that ejects liquid onto a medium to perform recording;
a waste liquid storage tank that stores waste liquid generated by the liquid ejection head ejecting the liquid;
a waste liquid absorption member that is provided in the waste liquid storage tank and that is configured to absorb the waste liquid; and
a rotating body that rotates while contacting a surface of the waste liquid absorption member.

2. The liquid ejection device according to claim 1, wherein
the waste liquid storage tank forms a box shaped body and
the waste liquid absorption member and the rotating body are disposed inside the box shaped body.

3. The liquid ejection device according to claim 2, wherein
the waste liquid storage tank includes
an upper container and
a lower container that is located below the upper container and that is attachable to and detachable from the upper container,
the rotating body is provided to the upper container, and
the waste liquid absorption member is provided to the lower container.

4. The liquid ejection device according to claim 1, wherein
the rotating body is configured by providing, on a rotation shaft, blades that elastically deform by contact with the waste liquid absorption member.

5. The liquid ejection device according to claim 1, wherein
plural rotating bodies are provided.

6. The liquid ejection device according to claim 1, wherein
the rotating body includes
a plurality of pulleys,
a belt that is wound around the pulleys and that rotates, and
a wiper that is provided on the belt and that elastically deforms by contact with the waste liquid absorption member.

7. The liquid ejection device according to claim 1, wherein
the rotating body is formed of a material configured to absorb the waste liquid and
the waste liquid absorption member is provided so as to be driven to rotate by contact with the rotating body.

8. The liquid ejection device according to claim 1, wherein
the waste liquid guided to the waste liquid absorption member is discharged from above the rotating body toward the rotating body.

9. The liquid ejection device according to claim 1, further comprising:
a transport roller that transports the medium in a transport path through which the medium is transported and
a motor that drives the transport roller, wherein
the rotating body rotates by receiving power from the motor.

10. The liquid ejection device according to claim 9, further comprising:
a cap configured to face the liquid ejection head;
a suction pump coupled to the cap; and
a power transmission section that, assuming that rotation direction of the motor when the medium is transported downstream by the transport roller is a forward rotation direction, transmits power of the motor to the suction pump when the motor rotates in a reverse rotation direction that is opposite to the forward rotation direction, wherein
the rotating body rotates in a first direction when the motor rotates in the forward rotation direction, and rotates in a second direction opposite to the first direction when the motor rotates in the reverse rotation direction.
